(19) United States
(12) Patent Application Publication
(10) Pub. No.: US 2004/0192376 A1
(43) Pub. Date: Sep. 30, 2004

(54) Multi-beam satellite collocation and channel power allocation

(76) Inventor: David P. Grybos, San Jose, CA (US)

Correspondence Address: Joyce Kosinski, Loral Space and Communications, Ltd., Suite 303, 655 Deep Valley Drive, Rolling Hills Estates, CA, 90274, US

(21) Appl. No.: 10/094,674

(22) Filed: Mar. 11, 2002

(51) Int. Cl. H04Q 7/20

(52) U.S. Cl. 455/552.1; 455/429; 455/562.1

(57) ABSTRACT

Satellite-based communication systems and methods that substantially collocate multibeam satellites and allow for incremental addition of network capacity by launching additional substantially collocated satellites. Exemplary systems and methods comprise a plurality of substantially collocated multi-beam satellites that are launched and that are configured to provide beam coverage using substantially the same multibeam pattern of beams so that the beam coverage of both satellites is available for simultaneous use. A processor onboard each of the satellites configures the multibeam pattern of beams. The processor assigns a frequency and polarization to each beam based upon frequency re-use, system performance and capacity requirements, assigns overlapping bandwidth allocations within a beam, assigns bandwidth and power per bandwidth, and selectively adjusts beam capacity and power based on network traffic requirements.

### BACKGROUND

The present invention relates generally to satellites, and more particularly, to multibeam satellite collocation and channel power allocation systems and methods.

The assignee of the present invention manufactures and deploys spacecraft that orbit the earth and which carry communication equipment, such as transponders, and the like.

The SES-Astra satellite constellation collocates fixed satellite service (FSS) satellites and turns fixed bandwidth transponders on and off. It is believed that SES-Astra constellation does not re-allocate bandwidth or power.

It would be advantageous to have systems and methods that permit collocation of multiple multibeam satellites and channel power allocation between the collocated satellites to increase the achievable orbital slot communication capacity, allow incremental constellation build up and allow redundant spare hardware to increase system reliability.

### SUMMARY OF THE INVENTION

To meet the above and other objectives, the present invention provides for satellite-based communication systems and methods that substantially collocate multibeam satellites and allow for incremental addition of network capacity by launching additional substantially collocated satellites. The technique for re-allocating transmit power assigned to beams covered by the multiple substantially collocated satellites allows continued use of satellite capacity previously in orbit.

Exemplary systems and methods comprise a plurality of substantially collocated multi-beam satellites that are launched and that are configured to provide beam coverage using substantially the same multibeam pattern of beams so that the beam coverage of both satellites is available for simultaneous use.

The multibeam pattern of beams and the corresponding assigned frequency and polarization of each beam can be determined and fixed during manufacture prior to launch of the plurality of substantially collocated multi-beam satellites. A processor assigns overlapping bandwidth allocations within a beam, assigns bandwidth and power per bandwidth, and selectively adjusts beam capacity and power based on network traffic requirements.

The multibeam pattern of beams and the corresponding assigned frequency and polarization of each beam may be changed on-orbit after launch by a processor onboard each of the satellites that additionally configures the multibeam pattern of beams in conjunction with an adaptive antenna, such as a phased array. The processor assigns a frequency and polarization to each beam based upon frequency re-use, system performance and capacity requirements, assigns overlapping bandwidth allocations within a beam, assigns bandwidth and power per bandwidth, and selectively adjusts beam capacity and power based on network traffic requirements.

The present invention thus re-assigns bandwidth and power assigned to a beam to allow the simultaneous use of multiple in-orbit satellites to cover the same beam. The present invention allows for the simultaneous use of collocated satellites that cover the same coverage area and multiple beam pattern. The present invention also allows the re-assignment of bandwidth and power assigned to a beam to provide on-orbit sharing of capacity to a beam served by two collocated satellites.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary satellite-based communication system in accordance with the principles of the present invention that implements simultaneous coverage of a multibeam pattern;

FIG. 2 is a plot that illustrates power versus polarization for single satellite coverage;

FIG. 3 is a plot that illustrates power versus polarization for dual satellite coverage in accordance with the principles of the present invention;

FIG. 4 illustrates a first exemplary method in accordance with the principles of the present invention; and

FIG. 5 illustrates a second exemplary method in accordance with the principles of the present invention.

### DETAILED DESCRIPTION

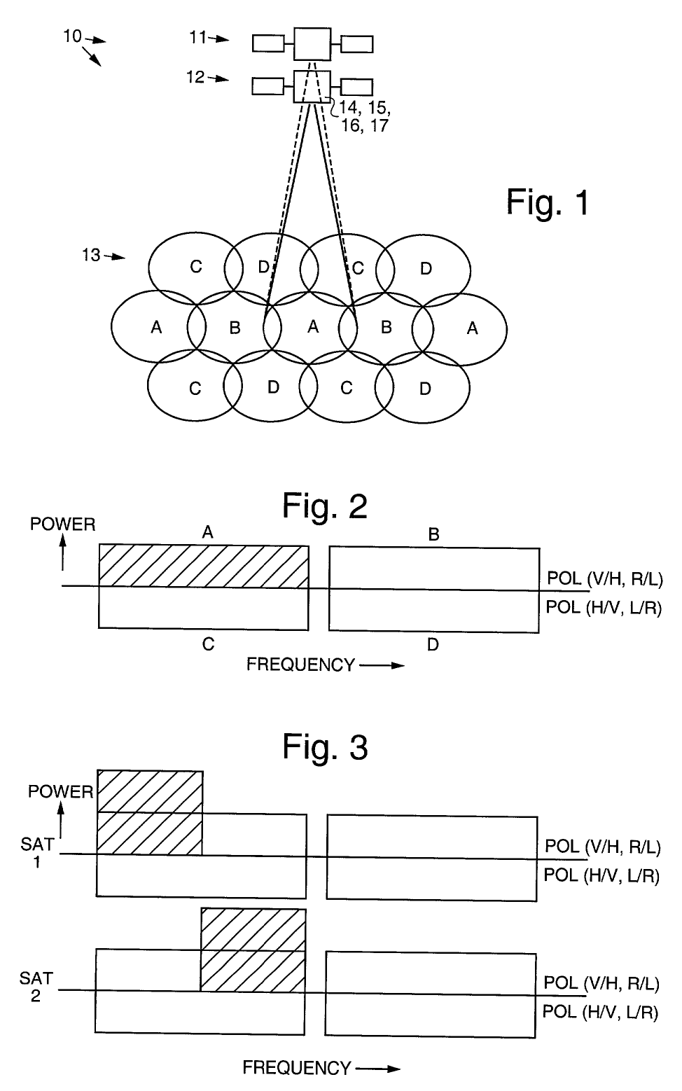

Referring to the drawing figures, FIG. 1 illustrates an exemplary satellite-based communication system 10 in accordance with the principles of the present invention. The satellite-based communication system 10 implements simultaneous coverage of a multibeam pattern of beams 13 from multiple satellites 11, 12.

The satellite-based communication system 10 comprises a plurality of substantially collocated multi-beam satellites 11, 12 that provide coverage using substantially the same beam coverage (i.e., the multibeam pattern of beams 13). Frequency and polarization assigned to each beam 13 is determined by frequency re-use, system performance and capacity requirements. A processor 20 onboard each of the satellites 11, 12 may be used to configure and control the multibeam pattern of beams 13.

The substantially collocated multi-beam satellites 11, 12 are assigned overlapping bandwidth allocations within a beam 13, as is shown in FIGS. 2 and 3. With regard to FIG. 2, it is a plot that illustrates power versus polarization for single satellite coverage.

Bandwidth and power per bandwidth are variable, as is shown in FIG. 3. With regard to FIG. 3, it is a plot that illustrates power versus polarization for dual satellite multibeam coverage in accordance with the principles of the present invention.

Bandwidth variability may be implemented by switched filters 14 (generally designated) or digital channelizers 15 (generally designated) disposed on the respective satellites 11, 12. Power variability may be implemented by adjusting the gain of each satellite channel when channel power amplifiers 16 (generally designated) are implemented using traveling wave tube amplifiers (TWTAs) 16 or other discrete power amplifiers disposed on the respective satellites 11, 12. Power variability may also be implemented by adjusting the satellite active antenna power allocation per beam 13, such as by using a phased array antenna 17 (generally designated), for example.

Capacity and power may be changed based on network traffic requirements. As is shown in FIG. 3, for example, each satellite 11, 12 may put twice the power in half the bandwidth. In this manner of bandwidth and power per bandwidth variation, the in-orbit assets of both satellites 11, 12 are available for simultaneous use.

Since both satellites 11, 12 provide bandwidth and power to the same beam(s) 13, each satellite 11, 12 can also serve as on-orbit back-up for the other. For example, if the satellites 11, 12 operate with twice the power in half the bandwidth (as is shown in FIG. 3) and one of the satellites 11, 12 experiences a failure, the operating satellite 11, 12 can revert back to nominal power over the full bandwidth (as is shown in FIG. 2).

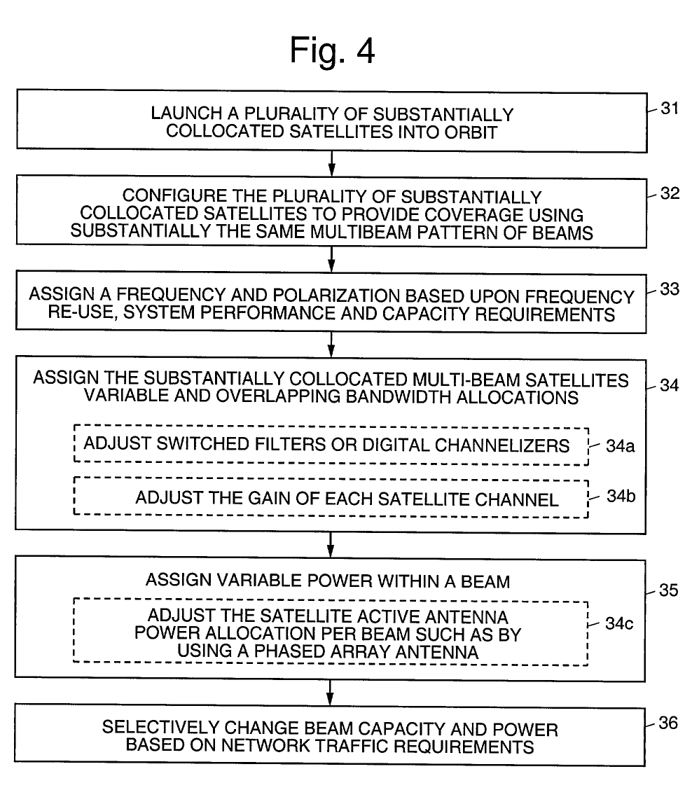

Referring now to FIG. 4, it illustrates a a first exemplary communication method 30 in accordance with the principles of the present invention. The first exemplary communication method 30 comprises the following steps.

A plurality of satellites 11, 12 are launched 31 into orbit at substantially the same orbital location (i.e., substantially collocated). The plurality of substantially collocated satellites 11, 12 are configured on-orbit 32 to provide coverage using substantially the same multibeam pattern of beams 13.

A frequency and polarization are assigned 33 to each beam 13 that is determined by frequency re-use, system performance and capacity requirements. The substantially collocated multi-beam satellites 11, 12 are assigned 34 variable and overlapping bandwidth allocations and are assigned 35 variable power within a beam 13. Beam capacity and power are selectively changed 36 based on network traffic and satellite failure and redundancy requirements.

For example, variable bandwidth allocations may be assigned 34 by adjusting 34a switched filters 14 or digital channelizers 15 disposed on the satellites 11, 12. Variable power allocations may be assigned 34 by adjusting 34b the gain of each satellite channel. This may be implemented when channel power amplifiers 16 are implemented using discrete power amplifiers 16 such as traveling wave tube amplifiers. Variable power allocations may also be assigned 34 by adjusting 34c the satellite active antenna power allocation per beam 13, such as by using a phased array antenna 17.

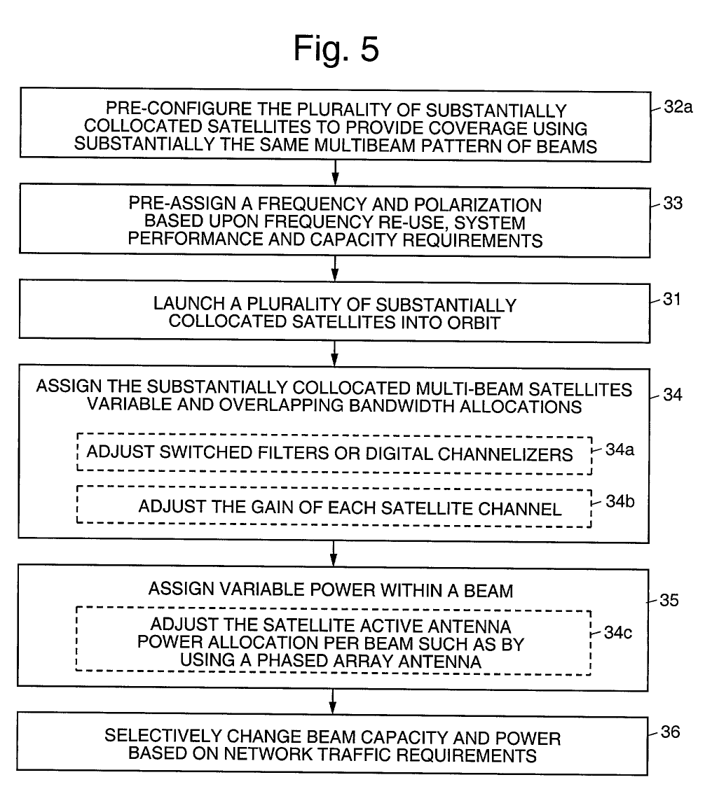

FIG. 5 illustrates a second exemplary method 30a in accordance with the principles of the present invention. The second exemplary communication method 30a comprises the following steps.

A plurality of satellites 11, 12 are manufactured 32a, or pre-configured 32a, to provide coverage using substantially the same multibeam pattern of beams 13. A predetermined frequency and polarization are pre-assigned 33 to each beam 13 that is determined by frequency re-use, system performance and capacity requirements. The plurality of satellites 11, 12 are launched 31 into orbit at substantially the same orbital location (i.e., substantially collocated). The substantially collocated multi-beam satellites 11, 12 are assigned 34 variable and overlapping bandwidth allocations and are assigned 35 variable power within a beam 13. Beam capacity and power are selectively changed 36 based on network traffic and satellite failure. redundancy requirements.

For example, variable bandwidth allocations may be assigned 34 by adjusting 34a switched filters 14 or digital channelizers 15 disposed on the satellites 11, 12. Variable power allocations may be assigned 34 by adjusting 34b the gain of each satellite channel. This may be implemented when channel power amplifiers 16 are implemented using discrete power amplifiers 16 such as traveling wave tube amplifiers. Variable power allocations may also be assigned 34 by adjusting 34c the satellite active antenna power allocation per beam 13, such as by using a phased array antenna 17.

Thus, multibeam satellite collocation and channel power allocation systems and methods have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A satellite-based communication system comprising:
a plurality of substantially collocated multi-beam satellites that provide beam coverage using substantially the same multibeam pattern of beams so that the beam coverage of both satellites is available for simultaneous use;
a processor disposed onboard each of the satellites that assigns overlapping bandwidth allocations within a beam, assigns bandwidth and power per bandwidth, and selectively adjust beam capacity and power based on network traffic and satellite failure. redundancy requirements.

2. The system recited in claim 1 wherein the processor assigns the bandwidth and power per bandwidth by adjusting switched filters disposed onboard the respective satellites.

3. The system recited in claim 1 wherein the processor assigns the bandwidth and power per bandwidth by adjusting digital channelizers disposed onboard the respective satellites.

4. The system recited in claim 1 wherein the processor assigns the bandwidth and power per bandwidth by adjusting the gain of each satellite channel by adjusting channel power amplifiers disposed onboard the respective satellites.

5. The system recited in claim 1 wherein the processor disposed onboard each of the satellites that configures the multibeam pattern of beams, which processor is configured to assign a frequency and polarization to each beam based upon frequency re-use, system performance and capacity requirements, assign overlapping bandwidth allocations within a beam, assign bandwidth and power per bandwidth, and selectively adjust beam coverage and capacity and power based on network traffic and satellite failure. redundancy requirements.

6. The system recited in claim 5 wherein the processor assigns the bandwidth and power per bandwidth by adjusting switched filters disposed onboard the respective satellites.

7. The system recited in claim 5 wherein the processor assigns the bandwidth and power per bandwidth by adjusting digital channelizers disposed onboard the respective satellites.

8. The system recited in claim 5 wherein the processor assigns the bandwidth and power per bandwidth by adjusting the gain of each satellite channel by adjusting channel power amplifiers disposed onboard the respective satellites.

9. The system recited in claim 5 wherein the processor assigns the bandwidth and power per bandwidth by adjusting satellite active antenna power allocation per beam using a phased array antenna disposed onboard the respective satellites.

10. A communications method comprising the steps of:
launching a plurality of substantially collocated satellites into orbit;
configuring the plurality of substantially collocated satellites to provide coverage using substantially the same multibeam pattern of beams;
assigning a frequency and polarization based upon frequency re-use, system performance and capacity requirements;
assigning the substantially collocated multi-beam satellites variable and overlapping bandwidth allocations;
assigning variable power within a beam; and
selectively changing beam capacity and power based on network traffic requirements.

11. The method recited in claim 10 wherein the step of assigning variable and overlapping bandwidth allocations comprises the step of adjusting switched filters disposed on the satellites.

12. The method recited in claim 10 wherein the step of assigning variable and overlapping bandwidth allocations comprises the step of adjusting digital channelizers disposed on the satellites.

13. The method recited in claim 10 wherein the step of assigning variable power allocations comprises the step of adjusting 34b the gain of each satellite channel.

14. The method recited in claim 13 wherein the step of adjusting the gain of each satellite channel comprises the step of adjusting the gain of discrete power amplifiers on each satellite.

15. The method recited in claim 13 wherein the step of adjusting the gain of each satellite channel comprises the step of adjusting the gain of traveling wave tube amplifiers on each satellite.

16. The method recited in claim 10 wherein the step of assigning variable power allocations comprises the step of adjusting satellite active antenna power allocation per beam.

17. The method recited in claim 16 wherein the step of adjusting satellite active antenna power allocation per beam comprises the step of adjusting a phased array antenna.

18. A communications method comprising the steps of:
pre-configuring the plurality of substantially collocated satellites to provide coverage using substantially the same multibeam pattern of beams;
pre-assigning a frequency and polarization based upon frequency re-use, system performance and capacity requirements;
launching a plurality of substantially collocated satellites into orbit;
assigning the substantially collocated multi-beam satellites variable and overlapping bandwidth allocations;
assigning variable power within a beam; and
selectively changing beam capacity and power based on network traffic requirements.

19. The method recited in claim 18 wherein the step of assigning variable and overlapping bandwidth allocations comprises the step of adjusting switched filters disposed on the satellites.

20. The method recited in claim 18 wherein the step of assigning variable and overlapping bandwidth allocations comprises the step of adjusting digital channelizers disposed on the satellites.

21. The method recited in claim 18 wherein the step of assigning variable power allocations comprises the step of adjusting the gain of each satellite channel.

22. The method recited in claim 21 wherein the step of adjusting the gain of each satellite channel comprises the step of adjusting the gain of discrete power amplifiers on each satellite.

23. The method recited in claim 21 wherein the step of adjusting the gain of each satellite channel comprises the step of adjusting the gain of traveling wave tube amplifiers on each satellite.

24. The method recited in claim 18 wherein the step of assigning variable power allocations comprises the step of adjusting satellite active antenna power allocation per beam.

25. The method recited in claim 24 wherein the step of adjusting satellite active antenna power allocation per beam comprises the step of adjusting a phased array antenna.
